(19) United States
(12) Patent Application Publication
(10) Pub. No.: US 2019/0322122 A1
(43) Pub. Date: Oct. 24, 2019

(54) MARQUETRY TEMPLATE AND METHODS OF USE THEREOF

(71) Applicant: Igor Zaloznyi, Milwaukie, OR (US)

(72) Inventor: Igor Zaloznyi, Milwaukie, OR (US)

(21) Appl. No.: 16/386,414

(22) Filed: Apr. 17, 2019

Related U.S. Application Data
(60) Provisional application No. 62/659,471, filed on Apr. 18, 2018.

(51) Int. Cl. B44C 1/16; B44C 1/26; B44C 3/08; B44C 5/04

(52) U.S. Cl. CPC B44C 1/162; B44C 5/04; B44C 3/082; B44C 1/26

(57) ABSTRACT

The presently disclosed subject matter relates generally to a marquetry template and methods of use thereof for creating a marquetry artwork. The marquetry template comprises an up to scale design. The design comprises design elements which are partly pre-cut and a user can easily cut them completely out of the template, thus creating cutouts and openings in the template. The cutouts, and/or openings, are used to produce suitably-sized pieces of material to be fitted in the openings of the template, thus creating a marquetry artwork.

This application claims the benefit of U.S. provisional application 62/659,471 filed Apr. 18, 2018.

### TECHNICAL FIELD

The presently disclosed subject matter relates generally to a marquetry template and methods of use thereof for creating a marquetry artwork.

### BACKGROUND

Marquetry is the art and craft of applying pieces of veneer, or any other material, to a structure to form decorative patterns, designs or pictures. The technique may be applied to case furniture or even seat furniture, to decorative small objects with smooth, venerable surfaces or to freestanding pictorial panels appreciated in their own right.

As an art form, Marquetry is beautiful and unique, but often too technically difficult for an unexperienced craftsperson to master. First, a design for the artwork has to be created, which requires drawing, and/or computer skills. Then, the aspiring marquetery artist has to transfer the design (or the various elements of it) to measurements of the pieces to be cut and applied to the artwork. Lastly, exact openings have to be created in the marquetry surface for embedding the cut pieces. All of the steps described above require skills, and therefore the enjoyable and useful hobby of marquetry is out of reach for most people.

The presently disclosed marquetry template makes marquetry an easy and accessible craft for a much wider population to enjoy. It supplies a user with a marquetry template comprising a design which is up to scale. The different design elements are partly pre-cut and the user can cut them completely out of the template with ease. The cutouts can then be used to mark with accuracy the outline of pieces to be embedded in the artwork. Subsequently, the user conveniently fits these pieces in the openings left in the template after cutting out the design elements, and thus the marquetry artwork is created.

### SUMMARY

In accordance with the present invention, various embodiments of the marquetry template and methods of use thereof are disclosed. In one embodiment, the present disclosure discloses a template for creating a marquetry artwork comprising a design, wherein said design comprises design element/s and said template has a thickness, and wherein said design elements are outlined in order to enable a user to cut along said outlines, thus creating a design element/s cutout/s, and a corresponding opening/s in said marquetry template.

In some embodiments, the presently disclosed marquetry template is fashioned from wood, wood veneer, polymeric material, plastic, cardboard, or paper.

In some embodiments, the thickness of presently disclosed marquetry template is in the range of 0.30-2.0 millimeters.

In some embodiments of the presently disclosed marquetry template, said outline of said design element/s is a cut contour cutting line.

In some embodiments of the presently disclosed marquetry template, each said design element cutout may be used to measure, or mark, an outline onto the surface of a material of choice, such that a piece of said material created by cutting along said measured, or marked, outline is similar to the outline of said used cutout, and thus may be fitted in said corresponding opening of said template. In some embodiments, said material of choice may be wood, wood veneer, bone, ivory, turtle-shell, mother-of-pearl, pewter, brass, or fine metals.

In other embodiments of the presently disclosed marquetry template, each of said openings may be used to measure, or mark, an outline onto the surface of a material of choice, such that a piece of said material created by cutting along said measured, or marked, outline is similar in outline to the outline of said used opening, and thus may be fitted in said used opening of said template. In some embodiments, said material of choice may be wood, wood veneer, bone, ivory, turtle-shell, mother-of-pearl, pewter, brass, or fine metals.

In yet other embodiments, the present disclosure provides a method of using the presently disclosed marquetry template, comprising the steps of:
(a) cutting out a design element along the contour cutting line, thus producing a cutout of said design element and a corresponding opening in said template;
(b) using the cutout of step (a) to mark an outline onto the surface of a material of choice, such that said marked outline is similar to the outline of said cutout;
(c) cutting a piece out of said material of step (b) along said marked outline of step (b);
(d) fitting said piece of step (c) in said corresponding opening of step (a); and
(e) repeating steps (a) to (d) as deemed necessary by a user to complete the creation of the marquetry artwork. A user may deem the marquetry artwork complete when all of the design elements in the template have been replaced by pieces of the material of choice, or prior to that.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a perspective view of one example of the presently disclosed marquetry template.

FIG. 2 illustrates a top view of one example of the presently disclosed marquetry template.

FIG. 3 is a photograph of pieces of veneer cut to size using the presently disclosed marquetry template.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The presently disclosed marquetry template comprises a marquetry design which is up to scale. In some embodiments, the various design elements are partly pre-cut and a user can cut them completely out of the template with ease. The cutouts can then be used to trace the outline of the design element onto a surface of a material of choice and cut along said traced outline to obtain pieces of material to be embedded in the artwork. Subsequently, the user can fit these pieces in the openings left in the template after cutting out the corresponding design elements, thus producing the marquetry artwork.

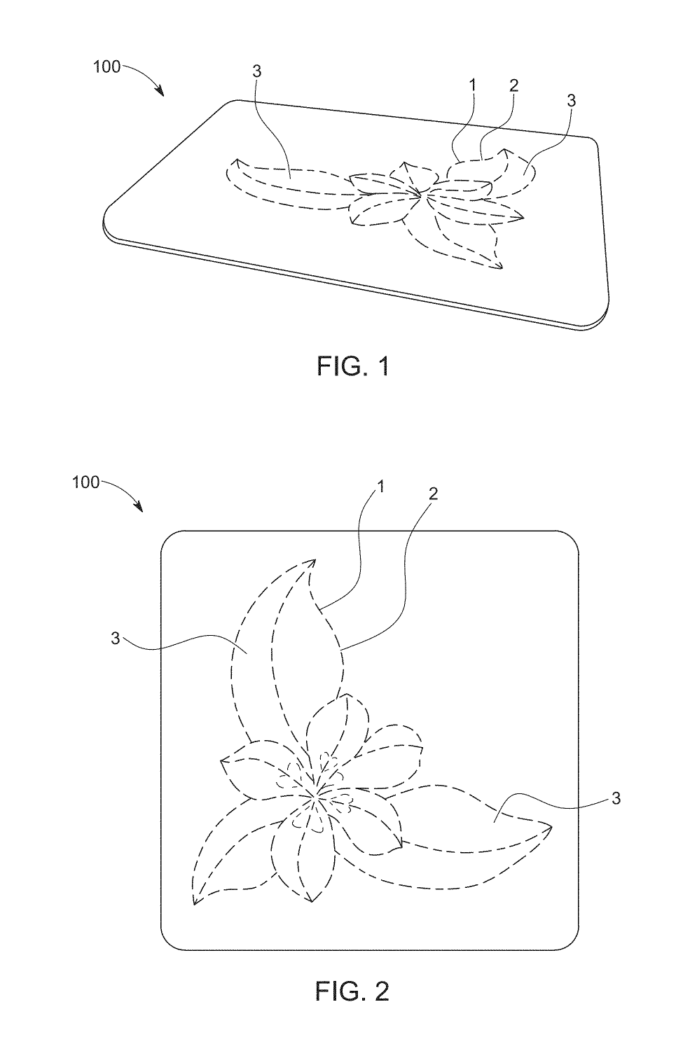

Referring now to FIG. 1, an illustration of one example of the presently disclosed marquetry template 100 (referred to herein as “marquetry template” or “template”) is shown. The template 100 comprises a design which is composed of design elements 3 (referred to herein as “design elements” or “elements”). The design shown in FIG. 1 is exemplary. The presently disclosed template 100 may comprise any design. A design according to the present disclosure may be any artistic design, drawing, picture, sketch, pattern, shape or combination of shapes, depiction, diagram, or a scheme. The design according to the present disclosure may relate to any context or subject, such as but not limited to still life, landscape, portraiture, nature, and abstract. The design according to the present disclosure may be composed of one or more elements 3. In some embodiments, the design comprises a few elements 3, for example in the range of 1-20. In other embodiments, the design comprises multiple elements 3, for example in the range of 20-1000, however it is expressly contemplated that some designs may comprise even more elements 3. Elements 3 of the design may vary in shape and size. Thus, a user may learn marquetry skills by using first templates 100 with simpler designs (which comprise fewer and easier elements 3), and gradually proceed to using templates 100 which comprise more elaborated designs. The template 100 of the present disclosure may comprise one or more designs, for example a template may comprise 1-10 designs. The percentage of the area of the template 100 designated for the design/s is in the range of 1-99%. Preferably, the percentage of the area of the template 100 designated for the design/s is in the range of 20-80%.

The elements 3 are outlined 1 to enable a user to conveniently cut the element/s 3 out of the template 100. The outline according to the present disclosure may be any outline that clearly marks the contour of the element/s 3. The outline may be, without limitation, a continues line, dotted line, or a broken line (an example of a broken line is shown in FIGS. 1 and 2). In some embodiments, the outline is drawn, inked, or printed on the surface of the template 100. In other embodiments, the outline is a contour cutting line. A contour cutting line according to the present disclosure, is an outline that is partly pre-cut. Thus, said contour cutting line may be a continues, dotted, broken, or dashed line, wherein the line is pre-cut either through the entire thickness of the template 100, or partly through the thickness of the template 100. When the line is pre-cut through the entire thickness of the template 100, the design elements 3 are partly separated from the template 100. In the embodiment illustrated in FIG. 1, the contour cutting line is a broken line 1 wherein said line 1 is pre-cut through the entire thickness of the template (not shown), thus the elements 3 are connected to the template via the uncut areas 2. In order to detach an element 3 from the template 100, a user has to cut only the uncut areas 2 along the contour of said element. This can be done simply and with any suitable cutting tool, such as, without limitation, any type of a knife. In some embodiments, the outline, or contour cutting line, width is in the range of 0.5-1.5 millimeters. In the embodiments in which the contour cutting line is a broken, dashed or dotted line, each uncut area 2 length is in the range of 1.00-4.00 millimeters. To create the template 100, any suitable computer software, tools, printing means, cutting means, or manufacturing means may be used. Such computer software includes, but is not limited to, Adobe Illustrator, CorelDRAW, and/or any suitable laser-cutter software. Similarly, the template 100 may be manufactured using any suitable machinery, such as a printer/cutter.

As one example of use, a chief purpose of the presently disclosed template 100 is to produce marquetry artwork, and/or inlay wood work, often with the use of wood veneer. In the process, a user uses the template 100 to cut out a design element 3, optionally by hand. The element 3, or the corresponding opening in the template left after said element 3 was cut out, is used for tracing an outline on a wood veneer. Subsequently, the wood veneer piece is cut out along said traced outline and can be fitted into the opening in the template 100, where the design element 3 used to trace it was cut out from. As each design element 3 is exchanged with wood veneer pieces, a completed marquetry artwork is created.

To enable fitting in cut pieces in the template, as described above, the presently disclosed template 100 has a thickness. In some embodiments, the thickness of the template 100 is in the range of 0.30-2.00 millimeters. In some embodiments, the thickness of the template 100 is 0.53 millimeters, or about 0.53 millimeters. In some embodiments, the thickness of the template 100 is similar to the thickness of wood veneer. A similar, or same, thickness of the template 100 and wood veneer, as discussed above, allows a user to easily fit the cut wood veneer pieces into the corresponding openings in the template 100 and, in addition, the top part of the marquetry artwork created is level, or mostly level, i.e. significantly free of bulges and depressions. Thus, a user can then easily finish the artwork using any desirable method, such as applying stains, paints, or simply framing it, without first having to level the top surface, for example, by sanding it. Furthermore, a certain thickness of the template 100, for example in the range mentioned above, helps a user move the cutting tool (such as a knife) securely and easily along the desired element contour line. The cutting tool being partly immersed in the template's thickness is easier to control, and less likely to mistakenly “deviate” from the contour line.

The template 100 may be fashioned out of any suitable material, or combination of one or more materials. Such materials include, without limitation, wood, wood veneer, plastic, polymeric material, cardboard, paper, or paper product. One skilled in the art will appreciate that any suitable type of wood, plastic, polymeric material, paper, or paper product may be used for manufacturing the template 100 without departing from the spirit and scope of the present disclosure.

The template 100 may have any desirable color or texture, or a combination thereof. For example, the design elements 3 may be color coded (or otherwise numbered or marked) in order to guide the user with regards to the marquetry assembly process, or possibly selection of material for use in the marquetry artwork.

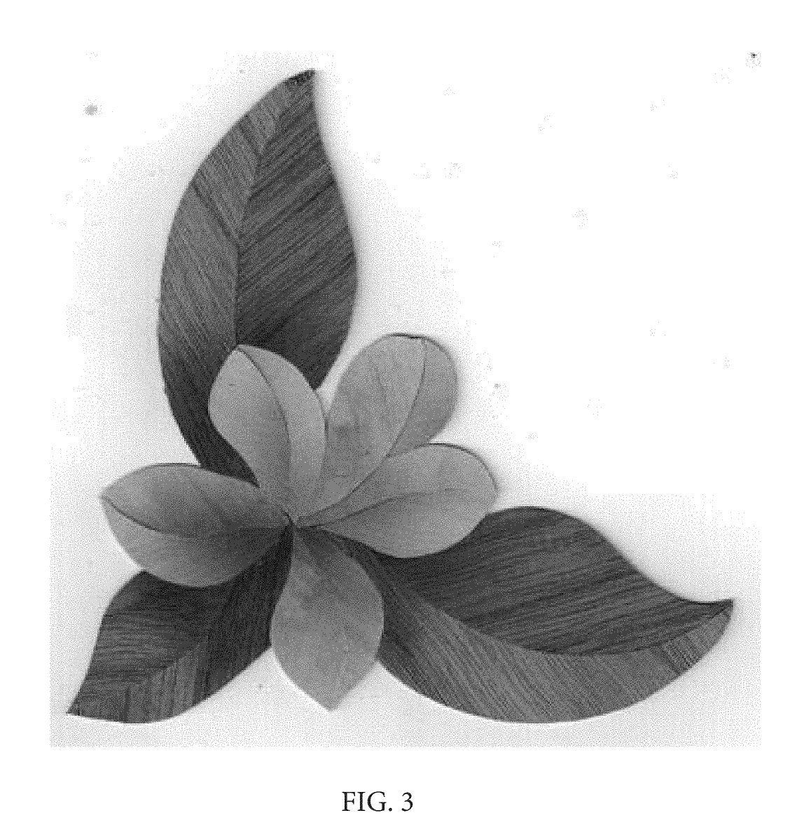

FIG. 2 illustrates another example of a marquetry template 100 comprising a design which comprises design elements 3. The elements 3 are outlined with a contour cutting line 1. The design illustrated in FIG. 2 has more elements 3 that the design of FIG. 1 and may be used by more advanced users. Otherwise, a user may decide whether to cut out two or more elements 3 as one cutout, or to cut out each element 3 separately. Pieces of veneer cut to size using design elements 3 cutouts, or openings in the marquetry template, as described herein are shown in FIG. 3

The present disclosure provides a method of using the presently disclosed marquetry template 100, generally comprising the steps of:
(a) cutting out a design element 3 along the contour cutting line, thus producing a cutout of said design element 3 and a corresponding opening in said template;
(b) using the cutout of step (a) to trace an outline onto the surface of a material of choice, such that said traced outline is similar to the outline of said cutout;
(c) cutting a piece out of said material of step (b) along said traced outline of step (b);
(d) fitting the cut piece of step (c) in said corresponding opening of step (a); and
(e) repeating steps (a) to (d) as deemed necessary by a user to complete the creation of the marquetry artwork. A user may deem the marquetry artwork complete when all of the design elements 3 in the template have been replaced by pieces of the material of choice, or prior to that.

Upon completion of the marquetry artwork, said artwork may be treated with polyurethane or stained. It may be displayed in anyway the user finds suitable. The marquetry artwork may also be taken out of the template and used to create an inlay wood work.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise.

Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

1. A template for creating a marquetry artwork comprising a design, wherein said template has a thickness and said design comprises design elements, and;
wherein each said design element is outlined in order to enable a user to cut along said outline, thus creating a design element cutout, and corresponding opening in said template.

2. The template of claim 1, wherein said template is fashioned from wood, wood veneer, plastic, polymeric material, cardboard, or paper.

3. The template of claim 2, wherein said thickness of said template is in the range of 0.30-2.0 millimeters.

4. The template of claim 3, wherein said outline of said design element is a contour cutting line.

5. The template of claim 4, wherein each said design element cutout may be used to measure, trace, or mark an outline onto the surface of a material of choice, such that a piece of said material created by cutting along said measured, traced, or marked outline is similar in outline to said used cutout, and thus may be fitted in said corresponding opening of said template.

6. The template of claim 4, wherein each of said openings may be used to measure, trace, or mark an outline onto the surface of a material of choice, such that a piece of said material created by cutting along said measured, traced or marked outline is similar in outline to said used opening, and thus may be fitted in said used opening of said template.

7. The template according to claims 5 and 6, wherein the material of choice may be wood, wood veneer, bone, ivory, turtle-shell, mother-of-pearl, pewter, brass, or fine metals.

8. A method of using the template according to claim 7, comprising the steps of:
(f) cutting out a design element along the contour cutting line, thus producing a cutout of said design element and a corresponding opening in said template;
(g) using the cutout of step (a) to trace an outline onto the surface of a material of choice, such that said traced outline is similar to the outline of said cutout;
(h) cutting a piece out of said material of step (b) along said traced outline of step (b);
(i) fitting said piece of step (c) in said corresponding opening of step (a); and
(j) repeating steps (a) to (d) as deemed necessary by a user to complete the creation of the marquetry artwork.
